(19) United States
(12) Patent Application Publication
(10) Pub. No.: US 2008/0062179 A1
(43) Pub. Date: Mar. 13, 2008

(54) DATA DISPLAY SYSTEM TO FACILITATE PATTERN RECOGNITION AND CLASSIFICATION

(75) Inventor: Rolando Manuel Branly, Miami, FL (US)

Correspondence Address: Rolando Manuel Branly, 6760 SW 27th Street, Miami, FL, 33155, US

(73) Assignee: Rolando Manuel Branly, Miami, FL (US)

(21) Appl. No.: 11/943,137

(22) Filed: Nov. 20, 2007

(51) Int. Cl. G09G 5/22; G06T 11/20

(52) U.S. Cl. 345/440.1

(57) ABSTRACT

A data display system and method to facilitate pattern recognition is disclosed. The display system can be used to monitor a live or pre-recorded data stream with the aim of determining instances in one dimensional data when the process generating the signal or numerical sequence has changed its fundamental characteristics. This is done by allowing a human operator to monitor and view data sets, along with their Fourier transforms and wavelet transforms on the same display system that emphasizes the relationship between them. The operator or viewer can make classification decisions based on his or her personal pre-established threshold criteria. The display system described uses hexagonal display regions that lend themselves to a graphical representation that facilitates an interconnected representation and decreases visual distractions for the viewer.

### TECHNICAL FIELD

The present invention relates to pattern recognition and, more particularly to a data display configuration that facilitates viewing an input signal and its mathematical transform with human operator input.

### BACKGROUND OF THE INVENTION

Pattern recognition systems are utilized in many areas of technology. Often times the process involves real time or nearly real time data viewed by an operator that aims to classify the input signals by comparing some of their parameters with pre-established numerical thresholds.

A human operator viewing a computer screen can benefit from a display system that shows the signal and its Fourier and wavelet transform together on the same screen along with a quick check method that indicates sudden changes in the fundamental system generating the signal. If a time dependent or other one dimensional signal remains fundamentally the same, the mathematical integral of the product of the signal times its Fourier transform will remain within an order of magnitude. An example is the application of the Heisenberg uncertainty principle in the field of quantum mechanics where the product of the position function of a particle times its momentum function are of the order of Planck's constant h divided by 2 pi (e.g. {delta(x)*delta(p)=h/(2*pi)}).

Many methodologies involving mathematical relationships have been implemented throughout the years for pattern recognition and signal discrimination. Nikitin et al. in a US patent application publication have presented a method and apparatus for the analysis of variables. Their method focuses on the analysis of variables through analog representations. The method presented in this application is different in that it focuses on the relationship between a signal and its fourier or wavelet transform. Jojic et al. (US patent) presents a system and method to facilitate pattern recognition by deformable matching. Their system presents several mathematical algorithms executed by a computer, whereas this application refers to a system that facilitates pattern recognition and classification with active human operator input to assist in the signal discrimination process.

Also important is the US patent application of Huang et al. which implements a weighted likelihood ratio for pattern recognition, and utilizes a reference spectrum as a point of comparison for pattern matching. The display system presented in this application instead assists the viewer monitoring a signal in determining when the process generating the signal has changed its fundamental characteristics.

### SUMMARY

This summary is presented as a means to introduce some of the concepts in a simple form which are further described below in the detailed description section. This summary is not intended to identify key features of the claimed subject matter.

A signal data display system can be used to monitor a live or pre-recorded data stream with the aim of determining instances in one dimensional data when the process generating the signal or numerical sequence has changed its fundamental characteristics. Since dynamic and physical processes are often generated through vibrations and oscillations viewing and monitoring both a signal and its representation in frequency space can be advantageous to human operator classification of data sets. Because it is difficult for a human operator to monitor two displays at once it is valuable to generate a third display that illustrates the relationship between a data set in one domain and its corresponding frequency domain. For example: the time and frequency domain, or the space and spatial frequency domain. This can add significant computational overhead for a multi-dimensional data set. For this reason this specification presents the one dimensional case. Multi-dimensional cases can be handled by parsing the data to generate a set of one dimensional data sets. The display system described uses hexagonal display regions that lend themselves to a graphical representation that facilitates an interconnected representation and decreases visual distractions for viewer.

### BRIEF DESCRIPTION OF THE DRAWINGS

FIG. 1. is a depiction of the Signal Data Display System.

FIG. 2. is a functional block diagram of the display system's data handling and processing hierarchy.

### DETAILED DESCRIPTION

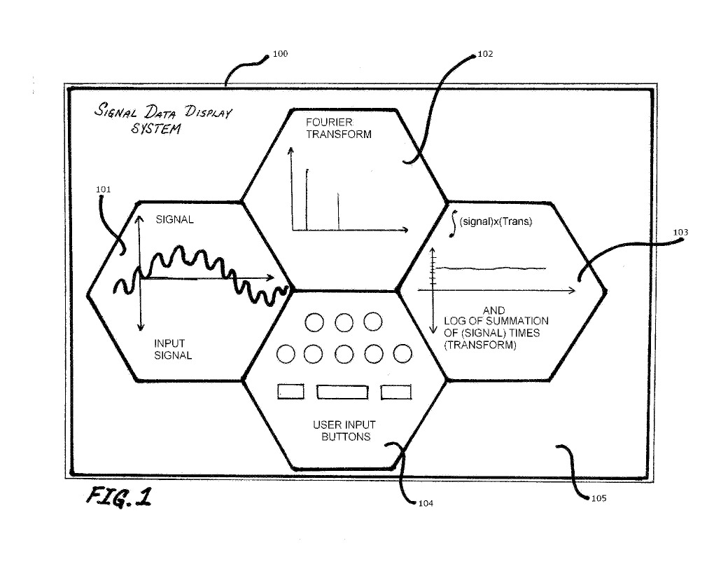

FIG. 1. illustrates an example of the preferred embodiment of a signal data display system 100. The system can be implemented on many varieties of computer monitors and display systems available in the industry such as cathode ray tubes (CRT's) or liquid crystal displays (LCD's). The display system 100 is comprised of several regions 101,102,103,104 and 105 (seen in FIG. 1.) that interconnect in order to facilitate viewing by a human operator monitoring “live” streaming data, or a pre-recorded one dimensional data set.

Region 101 illustrates the incoming signal obtained from a probe that outputs a voltage within a specified range, or the data sequence or numerical sequence from a digital computer file.

The display region 102 presents the Fourier transform or wavelet transform to the viewer. The display region 103 presents the viewer with the integral of the one dimensional signal times its transform (Fourier or wavelet) represented by a graphical and numerical display. It also shows the logarithm of the summation of the signal times its transform (Fourier or wavelet), depending on the viewer's choice. The viewer's choice is determined from interactions with input actuating devices 104 (labeled user input buttons in FIG. 1.). These may be implemented either through a common Graphical User Interface (GUI) or with physical buttons and knobs.

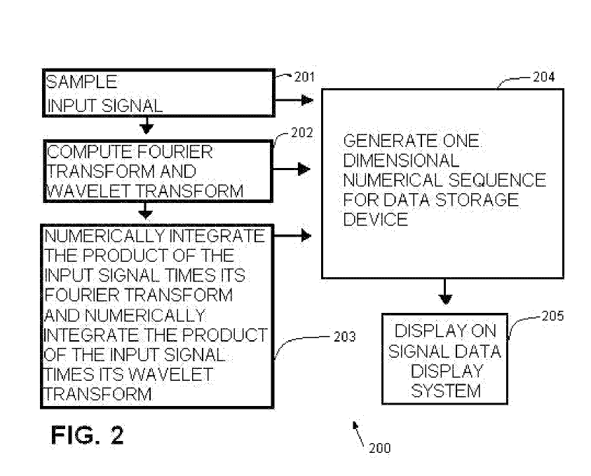

FIG. 2 presents a functional block diagram 200 illustrating the data handling path. The input signal is sampled 201. A one dimensional numerical sequence is generated for storage in computer memory 204, and the Fourier and wavelet transforms are computed 202. The results of the transformation are also stored in computer memory through module 204. The original signal times its transform (Fourier or wavelet, depending on the user's choice) are numerically integrated 203 to produce a third and final data set that is the stored 204. The numerical sequences or one dimensional data set are the displayed in a manner such as the one illustrated in FIG. 1.

The subject matter has been presented and described in a manner that discloses some example forms of implementing the claims. It is to be understood that the subject matter defined in the appended claims is not only limited to the specific features mentioned.

What is claimed is:

1. A data display system to facilitate pattern classification and recognition comprised of hexagonal display regions; the display regions contain depictions of an input one dimensional signal, and its Fourier or wavelet transform along with a graphical and numerical display of the integral or summation of the product of the input function times its Fourier transform.

2. The method of claim 1 comprised of polygonal display regions.

3. The method of claim 1 wherein the data display system includes a display region with user input actuators capable of modifying the display characteristics.

4. A data display system that highlights the relationship between a one dimensional signal and its Fourier and wavelet transforms through the use of display colors.
